(19) United States
(12) Patent Application Publication
(10) Pub. No.: US 2006/0216007 A1
(43) Pub. Date: Sep. 28, 2006

(54) Torpedo-shaped underwater camera-monitor combination

(76) Inventor: Philip Moreb, Rancho Mirage, CA (US)

Correspondence Address: HOFFMAN WASSON & GITLER, P.C;CRYSTAL CENTER 2, SUITE 522, 2461 SOUTH CLARK STREET, ARLINGTON, VA, 22202-3843, US

(21) Appl. No.: 11/171,204

(22) Filed: Jul. 1, 2005

Related U.S. Application Data
(60) Provisional application No. 60/584,164, filed on Jul. 1, 2004.

(51) Int. Cl. G03B 17/08

(52) U.S. Cl. 396/25

(57) ABSTRACT

A combination underwater camera and above-board monitor to view objects below the surface of a lake or other body of water as disclosed. This combination includes a waterproof carrying case in which a camera and a monitor would be housed. The camera is encased in a torpedo-like shell having a number of stabilizing fins attached thereto. In use, the camera would be submerged and a video cable would connect the camera to the video monitor housed within the carrying case located on a boat or vessel.

### CROSS-REFERENCED APPLICATION

The present application claims priority of provisional patent application Serial No. 60/584,164, filed on Jul. 1, 2004.

### FIELD OF THE INVENTION

The present invention relates to a system for underwater viewing of fish, boulders or other structures.

### BACKGROUND OF THE INVENTION

Fishing is likely the oldest recreational sport practiced in North America. Dating back to the 15th century, American Indians utilized fishing to obtain food, as well as to settle tribal disputes and more importantly, prepare and toughen warriors for battle. It is interesting that Indian legend has indicated that a man can view what is on the bottom of a lake merely by standing still and having a good eye. While it is arguable that this legend is true, what is true is that most fishermen do not possess this good eye to determine where in the lake fish happen to be. Consequently, modern day man has directed his attention to utilizing up-to-date technology to determine the best place in the lake to fish.

Prior art devices employ sonar technology to emit a high frequency signal to provide a graphic display of the region under and around a boat or ship. However, this technology is generally quite expensive and would only have application to commercial fishermen. Therefore, this particular technology would be difficult to be utilized by the average recreational fisherman. Consequently, a system must be developed in which a recreational fisherman would be allowed the benefit of determining what lies below a boat, when the boat is stationary as well as when that boat is propelled in a lake or other body of water. This technology would allow the individual fisherman to locate the existence and placement of fish in a lake, as well as enabling the fisherman to become aware of any dangerous conditions or structures in the lake, such as large rocks or boulders submerged only a few feet or inches from the surface of the water.

### SUMMARY OF THE INVENTION

The aforementioned deficiencies in the prior art are addressed by the present invention which is directed to a system for determining the location of fish or other submerged structures or objects in a lake or other bodies of water. The system includes a submersible camera connected by a cable to a monitor located on a boat. Due to the murkiness of various lakes or other bodies of water, the camera would be provided with a night-vision capability allowing the fish, large rocks, boulders or potentially dangerous other structures to be displayed upon the monitor. The camera would be housed in a specially designed waterproof casing provided with a fin structure allowing the camera to be relatively stable when it moves through the water as well as allowing the camera to move through various impediments, such as seaweed. Furthermore, the camera would be weighted for ballast.

Other objects of the invention will become apparent as the description proceeds in connection with the accompanying drawings.

### BRIEF DESCRIPTION OF THE DRAWINGS

FIG. 1 is a front perspective view of the present invention including an opened carrying case and monitor;

FIG. 2 is a view of a portion of the opened carrying case and underwater camera;

FIG. 3 is a top elevational view of the present invention including the opened carrying case and camera;

FIG. 4 is a front view of the carrying case of the present invention in the open position;

FIG. 5 is a side elevational view of the present invention including the opened carrying case and camera;

FIG. 6 is a side elevational view of the present invention including the opened carrying case and camera;

FIG. 7 is a side elevational view of the camera according to the present invention;

FIG. 8 is a top view of the camera of the present invention;

FIG. 9 is a side elevational view of the present invention submerged underwater;

FIG. 10 is a side perspective view of the camera and a portion of the opened carrying case;

FIG. 11 is a front perspective view of the camera resting on the opened carrying case; and

FIG. 12 is a perspective view of the carrying case in a closed position floating on the water.

### DETAILED DESCRIPTION OF THE PRESENT INVENTION

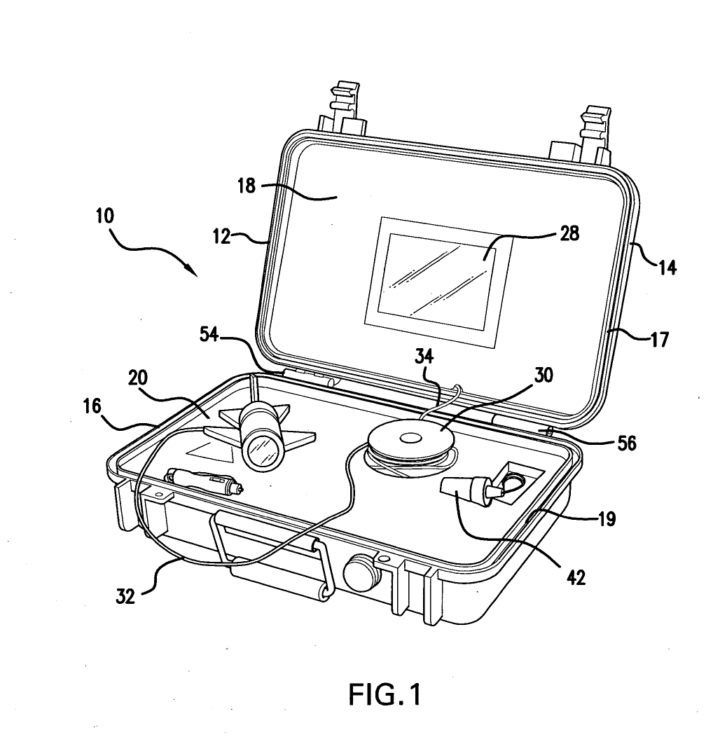

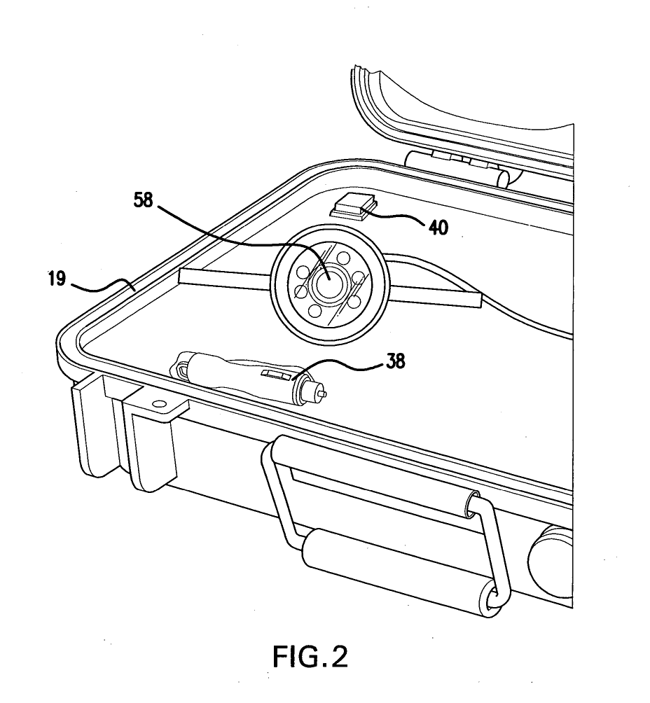

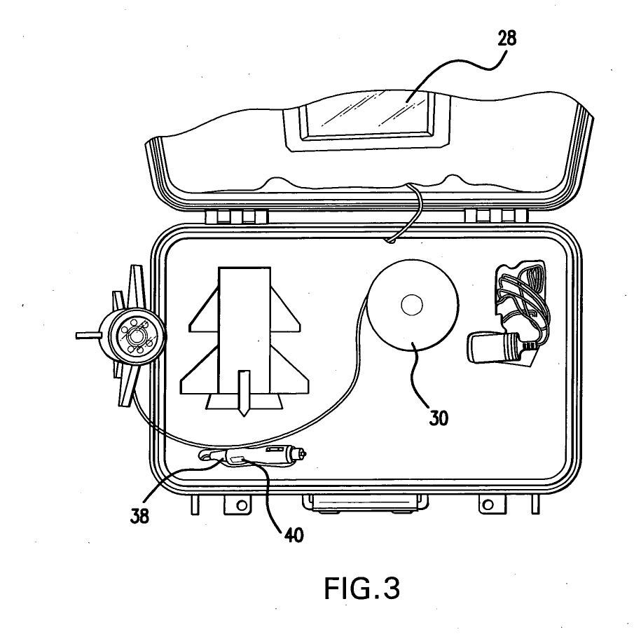

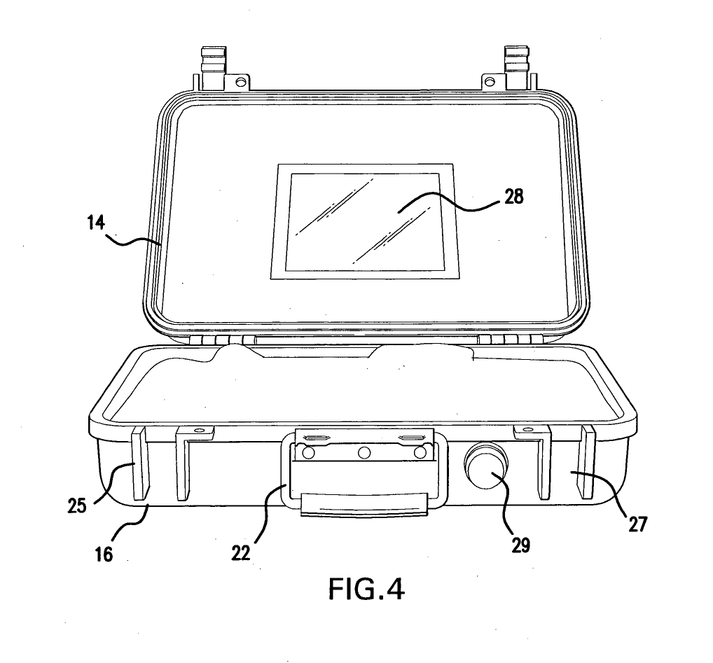

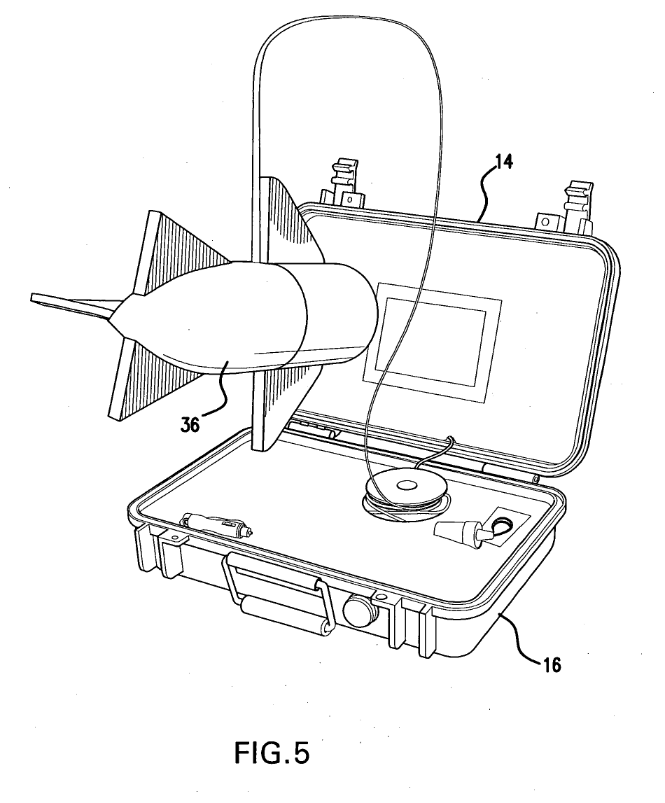

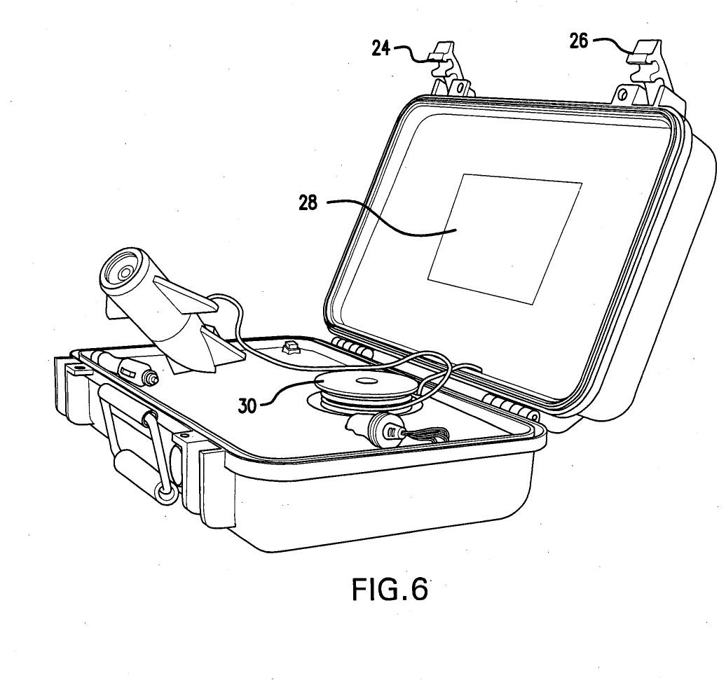

Referring to the drawings, particularly FIGS. 1-6, the invention 10 includes a lightweight, generally rectangular carrying case 12 provided with a top portion 14 hingingly connected to a bottom portion 16 utilizing two hinges 54, 56. The carrying case 12 is designed to house all of the components needed to operate the underwater camera, according to the present invention. The top portion of the carrying case is provided with state-of-the-art foam cushioning material 18 and the bottom of the carrying case 16 is provided with state-of-the-art foam cushioning material 20. Since all of the components of the underwater camera apparatus 10 are designed to be carried by the carrying case 12, sections of the cushioning material 18, 20 could be eliminated to accommodate the various components. In this situation the various components utilized in the present invention, with the exception of a viewing monitor 28, would rest on the top of the bottom cushioning material 20. The viewing monitor 28 would reside in a cut-out portion provided in the top cushioning material. A Velcro® type fastener or other securing devices would be used to hold the video monitor 28 in place.

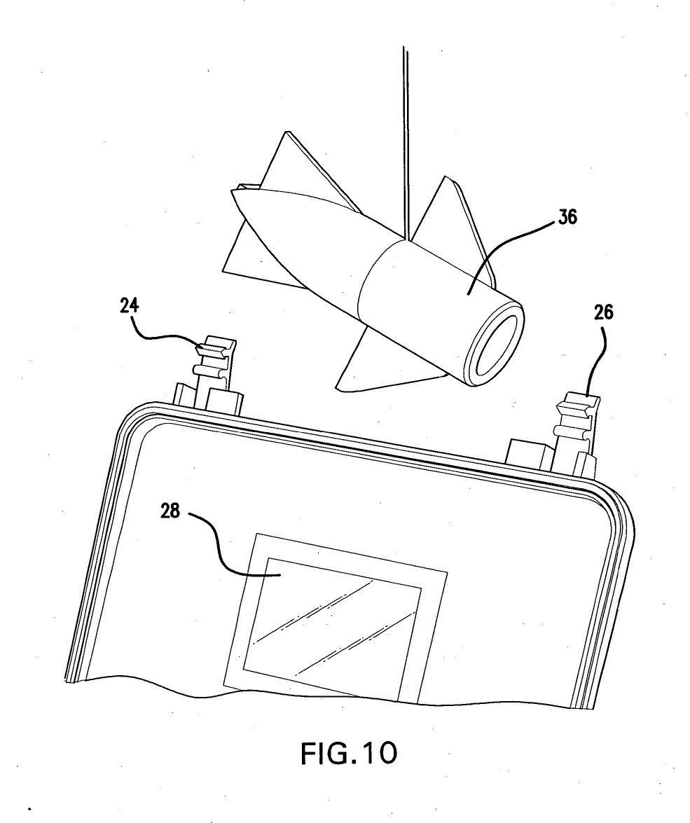

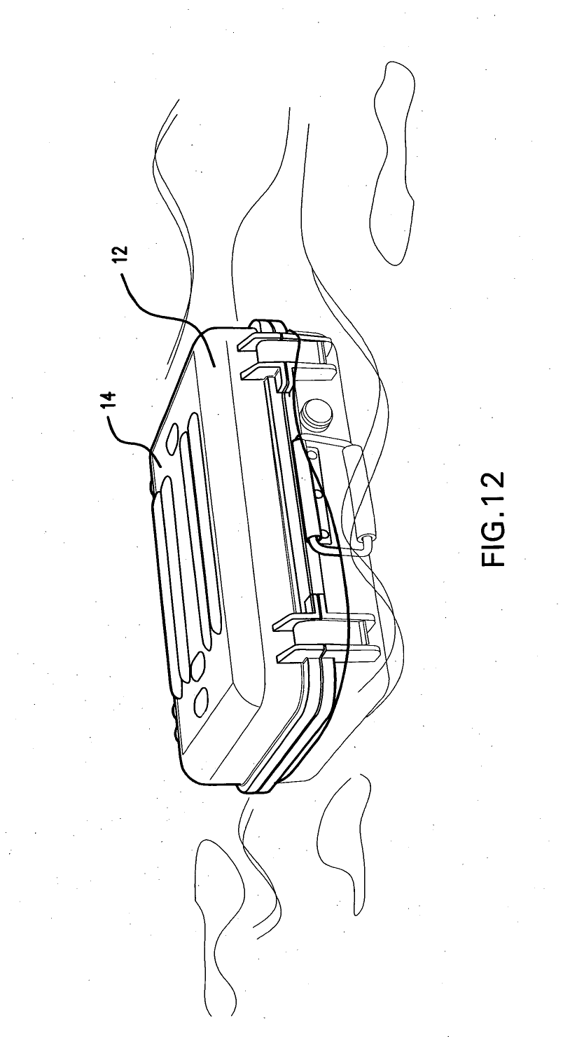

The exterior of the carrying case 12 would be constructed from any lightweight material, which would allow the carrying case to be waterproof and have the ability to float on water. A seam 17 would extend around the entire periphery of the top of the carrying case 14 and would cooperate with a slot 19 extending around the entire periphery of the bottom of the carrying case 16, so that when the carrying case is in the closed position (as shown in FIG. 12), the carrying case would be waterproof. A pair of clasps 24, 26 (see FIG. 10) would be affixed to the top portion of the carrying case 14 and would cooperate with locks 25, 27 to close the case in such a manner to assure the waterproof nature of the carrying case 12. An air-compressed valve is included in the case 12 to ensure that the case 12 remains water tight to protect the electronic contents of the case 12 if the case accidently enters the water as shown in FIG. 12. A knob 29, when rotated in a counterclockwise direction would act to release the air within the case 12 to equalize the pressure within the case. Even when the case 12 is in the open position as shown in FIG. 1, the cushioning material 18, 20 would act to protect the electric contents of the case 12 if the water would splash therein. Although not shown in the drawings, one or more key-lock combinations could be utilized to lock one or both of the latches 24, 26 in place.

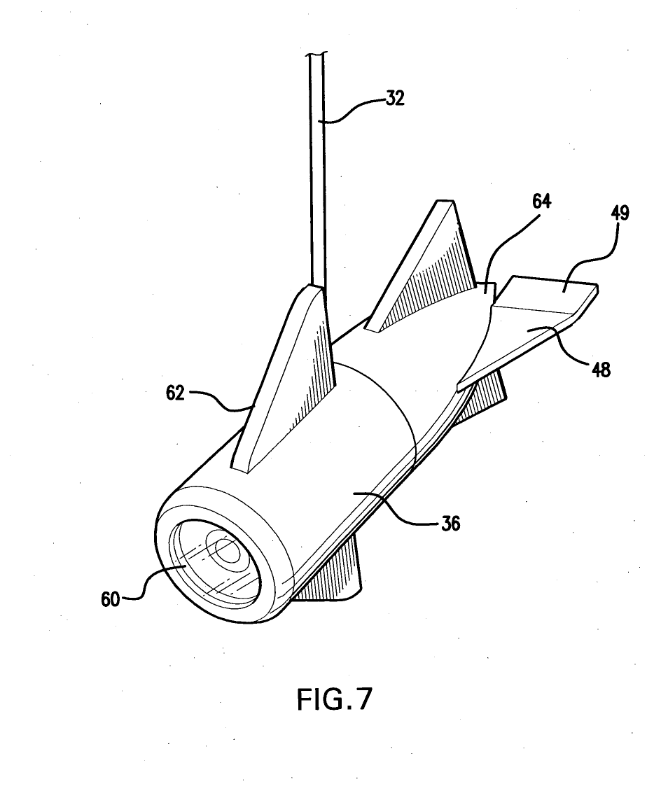

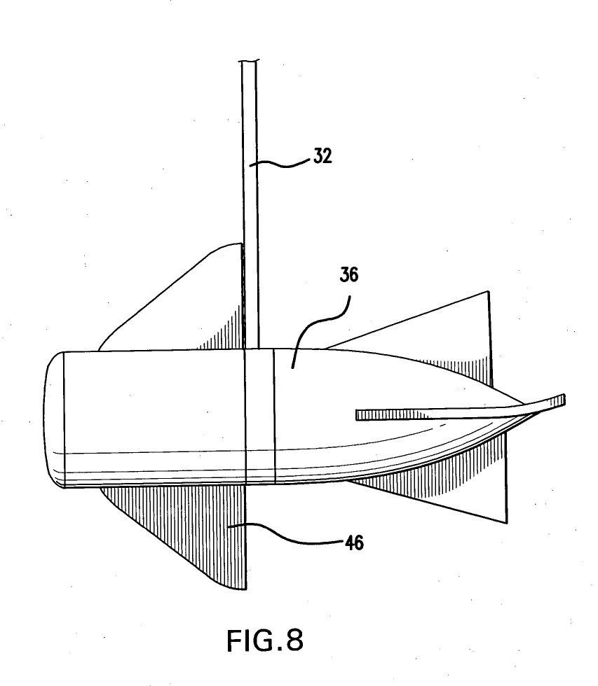

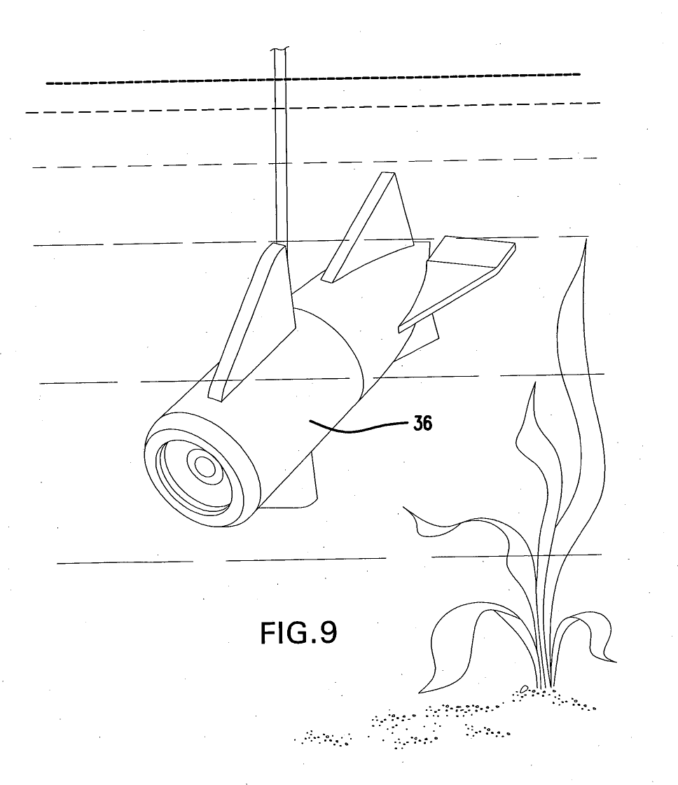

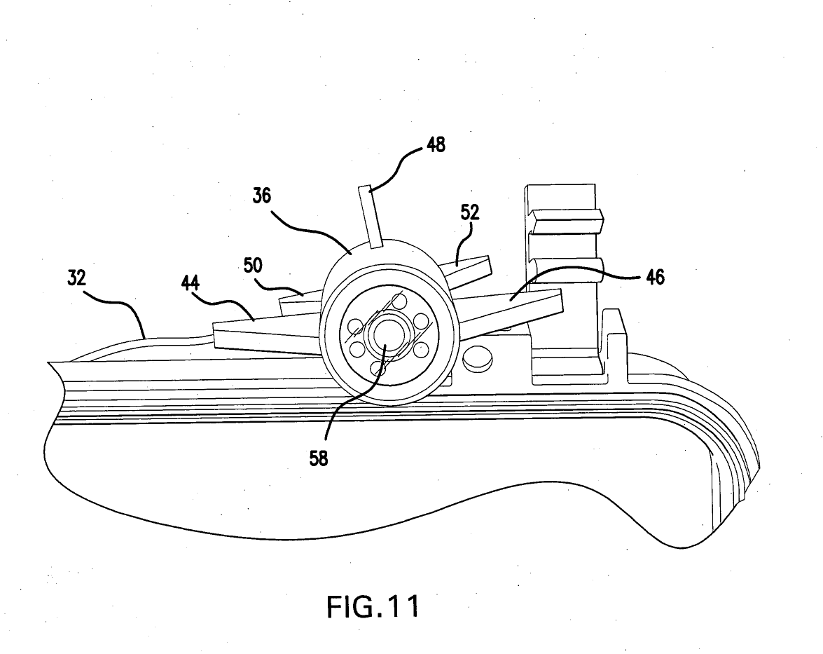

Referring particularly to FIGS. 7-11, a camera 36 would be utilized to view the water below the boat. The camera would be housed in a waterproof housing and would include one or more infrared light-emitting diodes therein, similar in nature to a night vision camera. The waterproof housing of the camera 36 would be constructed from brass, or similar material. The camera would include a fixed focus lens, such as a 36 mm fixed focus lens, and a built-in electronic shutter. The camera includes a charge coupled device (CCD) image sensor as well as a scanning and synchronizing system. The camera is directly connected to a video cable 32 to transmit the received images from the camera to the video monitor 28 mounted in the top of the carrying case 14. A cable reel 30 would hold a length of the video cable 32 to allow the camera 36 to be submerged into the water to a particular depth, such as between 60 to 90 feet. Certainly, based upon the depth of the lake or other water in which the camera 36 is submerged, the length of the cable which is played out from the cable reel 30 could easily be changed. A video cable 34 is provided to connect the video cable 32 to the monitor 28. It is noted that any type of video monitor, such as an LCD monitor may be utilized. It is also noted that the monitor 28 could produce either color or black and white images. The size of the monitor is an important feature of the present invention. However, it has been found that monitors having a width of four inches and a length of seven inches work particularly well.

A source of power, such as a 12 volt DC battery 38, is used to power the entire system. The battery 38 is directly connected by a suitable cable or wire to the camera 36 and, in turn, to the monitor 28. For example, the video cable 32 can be used to both transmit a signal to be received and processed by the monitor 28 as well as to deliver the proper power to operate the system. An ON/OFF switch 40 would be employed to turn on or turn off the entire system. Alternatively, an adapter could be utilized instead of the battery to power the camera/monitor combination through an external AC or DC power source, such as an external battery or generator. A battery charger 30 is included in the carrying case 12, allowing the battery 38 to be recharged on a periodic basis.

FIGS. 7-11 show the camera 36 including the appropriate lens 58 in more detail. The camera is housed in a waterproof, torpedo-shaped housing having a relatively cylindrical front end shell 62 extending from a rounded front section 60 to a rear tapered shell section 64. It is noted that the front cylindrical section 62 extends for approximately half the length of the camera 36 and the rear tapered portion 64 extends for the remaining half of the waterproof shell ending at a point at the end of the tapered portion 64. The combination of the sections 62 and 64 would create a torpedo-like shape. The purpose of this configuration is to ensure that the camera 36 would move efficiently through the water when the boat is propelled through the water. This particular configuration would also allow the camera 36 to move through various impediments, such as seaweed, without being ensnarled therein and with the camera losing its efficiency. A plurality of fins are integrally attached to the exterior of the torpedo-like shell to stabilize the camera as it moves through the water. These fins include two fins 44, 46 integrally attached to the front cylindrical portion 62 of the torpedo-like shell as well as three fins 48, 50, 52 integrally attached to the rear tapered portion 64 of the torpedo-like shell. The combination of the torpedo-like waterproof shell, as well as the plurality of fins 44, 46, 48, 50 and 52, will be used to ballast the camera within the waterproof torpedo shell to assist in the proper movement of the camera through the water.

Each of the fins 44 and 46 are fixed to the front cylindrical section 72 very close to the camera lens. The fins 44 and 46 are diametrically opposed to one another, thereby being separated by approximately 180° from one another. Each of the fins 44 and 46 angle away from the front cylindrical section 62 at a range of between 30° and 40°.

The majority of the length of the fins 50 and 52 are integrally affixed to the rear tapered section 64. Each of the fins 50 and 52 are parallel to one of the fins 44 and 46, and exhibit an angle from the rear tapered section in the range of between 10° and 20°. The front portion of each of the fins 50 and 52 are fixed to the rear portion of the front cylindrical section 62 and extend along the majority of the length of the rear tapered section 64, terminating immediately in front of the pointed termination of the rear tapered section 64. Similar to the fins 44 and 46, the fins 50 and 52 are separated 180° from one another.

Fin 48 is attached to the rear tapered section 64 in a manner similar to the fins 50 and 52 and is separated 90° from each of the fins 50 and 52. The fin 48 is parallel to one of the fins 44 or 46 and is tapered at an angle of between 10° and 20°. A rear portion 49 is affixed to the end of the fin 48 and is angled in the range of between 10° and 20° from the front portion of the fin 48.

As shown in FIG. 7, when the camera 36, suspended by the cable 32, is not in the water, the camera 36 would be approximately 45° from the horizontal. Where the camera enters the water, it would do so at the 45° angle from the horizontal. However, when the camera is completely submerged in the water, it will take a position of approximately the horizontal position, parallel to the surface of the water when the boat begins to move. This would be due to the particular weight ballast of the camera's shell. This is important to ensure that the camera would take and the monitor would receive a level picture.

The operation of the underwater camera/monitor system will now be described. As previously indicated, the purpose of this system is to allow an individual on a boat, such as a recreational fisherman, to be apprised of the location of any fish below the surface of a lake or other body of water, as well as any underwater structures or impediments, such as rocks or boulders, which would be of interest to the fisherman or another individual. Once the boat reaches a particular position on the lake or other body of water, the carrying case 12, opened, and the cable 32 connected to the camera 36 would be unreeled from the cable reel 30 until it reaches the end of the reel or to a predetermined depth. Although not shown in the drawings, the cable 32 could be marked at various increments to determine a particular depth. Once the camera 36 is lowered to that particular depth, the system would be turned on utilizing the switch 40 at which time any image picked up by the camera 36 would be transmitted to the monitor 28 and displayed thereon. At that time, the boat could begin to move, allowing the fisherman to determine the location of a fish submerged below the boat. Based upon this information, the fisherman would be able to locate the position of the fish or a particular fish of interest and could then utilize a particular lure which the fisherman believes to be appropriate for the fish shown on the monitor 28. At that time, the ON/OFF switch 40 could be used to turn the system off, thereby saving power. If the fisherman wishes to move to another spot, the boat would begin to be moved through the water and the ON/OFF switch 40 would then be engaged to reinitiate operation of the system. At the end of the fishing session, with the system in the OFF mode, the cable 32 would be reeled onto the cable reel 30, at which time the camera would be reinserted into the interior of the carrying case 12, which could be closed. Based upon the capacity of the battery 38, the battery charger 42 might be engaged to recharge the battery so that it would be fully charged when the system is subsequently utilized.

While the invention has been described and illustrated in detail, it is to be understood that this is intended by way of illustration and example only.

What is claimed is:

1. An underwater camera, comprising:
a camera lens;
an image sensor; and
a casing in which said lens and said sensor are housed, said casing including a front cylindrical section and a rear section integrally connected to said front cylindrical section, said rear section tapering to an end termination point, said front cylindrical section and said rear section forming a torpedo-like shape, said casing further including a first set of fins connected to the exterior of said front cylindrical section and a second set of fins connected to the exterior of said rear section;
wherein said torpedo-like shape and said first and second set of fins allow the camera to maintain a stabilized orientation when the camera moves through the water.

2. The underwater camera in accordance with claim 1, wherein said image sensor is a CCD.

3. The underwater camera in accordance with claim 1, wherein said first set of fins include two fins attached to said front cylindrical section and separated from one another by approximately 180°.

4. The underwater camera in accordance with claim 3, wherein said second set of fins include two fins attached to said rear section and separated from one another by approximately 180°.

5. The underwater camera in accordance with claim 4, wherein said second set of fins include a third fin attached to said rear section, between said two fins attached to said rear section.

6. The underwater camera in accordance with claim 5, wherein said third fin includes a rear portion angled from said third fin at an angle between 10° and 20°.

7. An underwater camera system, comprising:
a camera lens;
an image sensor;
a casing in which said lens and said sensor are housed, said casing including a front cylindrical section and a rear section integrally connected to said front cylindrical section, said rear section tapering to an end termination point, said front cylindrical section and said rear section forming a torpedo-like shape, said casing further including a first set of fins connected to the exterior of said front cylindrical section and a second set of fins connected to the exterior of said rear section; and
a monitor connected to said casing by a cable for viewing an image captured by said image sensor;
wherein said torpedo-like shape and said first and second set of fins allow the camera to maintain a stabilized orientation when the camera moves through the water.

8. The underwater camera system in accordance with claim 7, further including a carrying case for housing said monitor, and further for housing the camera when the camera is not in use.

9. The underwater camera system in accordance with claim 8, wherein said carrying case is waterproof.

10. The underwater camera system in accordance with claim 9, wherein said carrying case is provided with a device for equalizing the pressure within said carrying case, when said carrying case is closed.
